(19) United States
(12) Patent Application Publication
(10) Pub. No.: US 2025/0125930 A1
(43) Pub. Date: Apr. 17, 2025

(54) METHODS, DEVICES, AND SYSTEMS FOR WIRELESS TRANSMISSION WITH LIMITED CHANNEL BANDWIDTH

(71) Applicant: ZTE Corporation, Shenzhen (CN)

(72) Inventors: Shuai ZHOU, Shenzhen (CN); Xing Liu, Shenzhen (CN); Xianghui Han, Shenzhen (CN)

(73) Assignee: ZTE Corporation, Shenzhen (CN)

(21) Appl. No.: 18/967,096

(22) Filed: Dec. 3, 2024

Related U.S. Application Data
(63) Continuation of application No. PCT/CN2023/076561, filed on Feb. 16, 2023.

(51) Int. Cl. H04L 5/00

(52) U.S. Cl. CPC H04L 5/0051; H04L 5/0092

(57) ABSTRACT

The present disclosure describes methods, systems and devices for wireless communication with limited channel bandwidth. One method includes determining, by a user equipment (UE), a transmission bandwidth, by receiving a synchronization signal or physical broadcast channel (SS/PBCH) block (SSB), wherein the transmission bandwidth is among a plurality of transmission bandwidths under a channel bandwidth, and the channel bandwidth is smaller than a bandwidth threshold.

### TECHNICAL FIELD

The present disclosure is directed generally to wireless communications. Particularly, the present disclosure relates to methods, devices, and systems for wireless communication with limited channel bandwidth.

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

With the rapid evolution of cellular mobile communication systems, more and more cells will be operated at higher frequencies. For the 5th Generation mobile communication technology, the supported minimum bandwidth may be 5 MHz with a sub-carrier spacing (SCS) of 15 KHz in normal circumstances. In some special scenarios, railway (e.g., future railway mobile communication system (FRMCS)) may have an available frequency domain resources of 2.8˜3.6 MHz, and smart grids and/or public safety and/or public protection and disaster relief (PPDR) may have an available frequency resources may be about 3 MHz, wherein the available frequency domain resources of some operators may be less than 5 MHz. The available frequency domain resources may be different when the bandwidth is less than 5 MHz. In different service scenarios, the UE needs to know what the actual available transmission bandwidth is. For example, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation. SSB block may include a primary synchronization signal (PSS) block and/or a secondary synchronization signal (SSS) block. For another example, a limited bandwidth (e.g., less than 3.6 MHz) may reduce an aggregation level supported by a control resource set (CORESET), leading to a shortage of physical downlink control channel (PDCCH) coverage.

The present disclosure describes various embodiments for wireless communication with limited channel bandwidth, addressing at least one of issues/problems discussed above, minimizing the degradation of PBCH reception, minimizing the degradation due to shortage of PDCCH coverage, and thus improving the performance of the wireless communication.

### SUMMARY

This disclosure relates to methods, systems, and devices for wireless communication and more specifically, for wireless communication with limited channel bandwidth.

In one embodiment, the present disclosure describes a method for wireless communication. The method includes determining, by a user equipment (UE), a transmission bandwidth, by receiving a synchronization signal or physical broadcast channel (SS/PBCH) block (SSB), wherein the transmission bandwidth is among a plurality of transmission bandwidths under a channel bandwidth, and the channel bandwidth is smaller than a bandwidth threshold.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of an exemplary embodiment for wireless communication.

FIG. 1C shows a schematic diagram of another exemplary embodiment for wireless communication.

FIG. 2 shows an example of a network node.

FIG. 3 shows an example of a user equipment.

FIG. 4 shows a schematic diagram of an exemplary embodiment for wireless communication.

FIG. 5 shows a flow diagram of a method for wireless communication.

FIG. 6A shows a schematic diagram of an exemplary embodiment for wireless communication.

FIG. 6B shows another schematic diagram of an exemplary embodiment for wireless communication.

FIG. 7 shows an example of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for wireless communication with limited channel bandwidth.

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

With the rapid evolution of cellular mobile communication systems, more and more cells will be operated at higher frequencies. For the 5th Generation mobile communication technology, the supported minimum bandwidth may be 5 MHz in normal circumstances (e.g., when the subcarrier spacing (SCS) is 15 KHz). In some special scenarios, such as railway (e.g., future railway mobile communication system (FRMCS)), smart grids, and/or public safety, the available frequency domain resources of some operators may be less than 5 MHz (e.g., 2.8˜3.6 MHz or 3 MHz). The available frequency domain resources may be different when the bandwidth is less than 5 MHz. In different service scenarios, the UE needs to know the actual available transmission bandwidth.

There may be various issues/problems when the available frequency resources is less than a bandwidth threshold (e.g., 5 MHz). Some issues/problems may include that, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation or failure to work. SSB block may include a primary synchronization signal (PSS) block and/or a secondary synchronization signal (SSS) block. Another issue/problem may include that a limited bandwidth (e.g., less than 3.6 MHz) may reduce an aggregation level supported by a control resource set (CORESET), leading to a shortage of physical downlink control channel (PDCCH) coverage. Another issue/problem may include that, the available frequency domain resources may be different when the bandwidth is less than 5 MHz. In different service scenarios, the UE needs to know the actual available transmission bandwidth. For example, FRMCS may require quite flexible L1 transmission bandwidth in band n100 to support gradual migration from global system for mobile communication-railway (GSM-R) to FRMCS. Another issue/problem may include the signal performance loss on some channels due to the available bandwidth is less than 5 MHz.

The present disclosure describes various embodiments for wireless communication with limited channel bandwidth. These various embodiments may have some of the following benefits: providing solutions to identify the different transmission bandwidth, addressing at least one of issues/problems discussed above, minimizing the degradation of PBCH reception, minimizing the degradation due to shortage of PDCCH coverage, and thus improving the performance of the wireless communication.

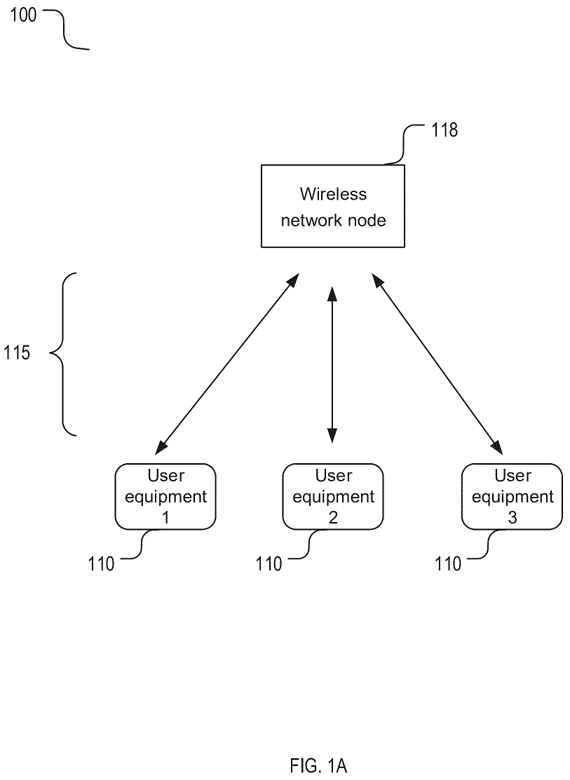

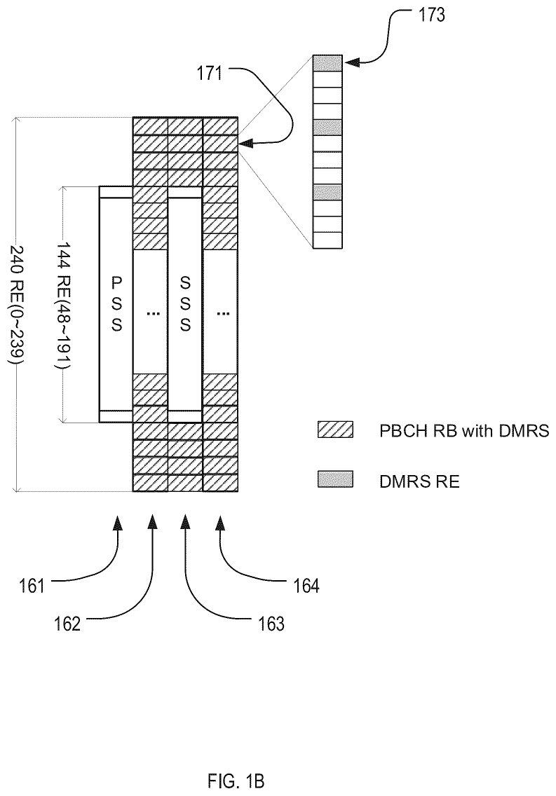

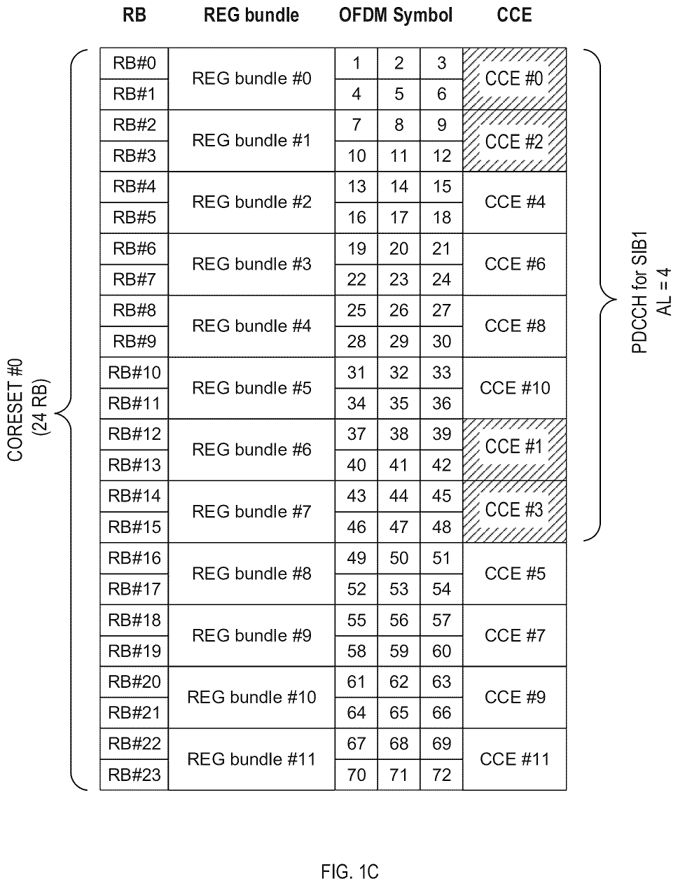

FIG. 1A shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115. For example, a first UE 110 may wirelessly communicate with a wireless network node 118 via a channel including a plurality of radio channels during a certain period of time. The network base station 118 may send high layer signalling to the UE 110. The high layer signalling may include configuration information for communication between the UE and the base station. In one implementation, the high layer signalling may include a radio resource control (RRC) message.

FIG. 1B shows an example of a structure of a synchronization signal (SS)/physical broadcast channel (PBCH) (SS/PBCH) block (SSB). The SS/PBCH block occupies 20 resource blocks (RBs) in the frequency domain and 4 consecutive time domain symbols. The first symbol (161) is mapped to a primary synchronization signal (PSS), the third symbol (163) is mapped to a secondary synchronization signal (SSS) and a physical broadcast channel (PBCH), and the second symbol (162) and the fourth symbol (164) are mapped to PBCH. Each RB (171) of PBCH may include 3 demodulation reference signal (DMRS) resource elements (REs) (173) for channel estimation. In some implementations, a CORESET may occupy the frequency domain resource at least 24 RBs.

In some implementations, the SS/PBCH block consists of 240 contiguous subcarriers (or resource elements (REs)) or 20 RBs in the frequency domain and 4 OFDM symbols in the time domain. The detail resource mapping of signals (including PSS, SSS, PBCH DMRS) and channel (PBCH) are shown in FIG. 1B. More specifically, in time domain, PSS and SSS occupy the first and the third symbol in the SS/PBCH block respectively. And PBCH are mapping in the second, third and fourth symbols. In frequency domain, PSS and SSS occupy RE 48-RE 191. For the second and forth symbols, PBCH occupies all of the 240 REs or 20 PRBs of the SS/PBCH block, and for the third symbol, PBCH occupies RE 0-RE 47 (i.e., RE 0-RE 3) and RE 192-RE 239 (i.e., RE 16-RE 19). In each PBCH PRB, DMRS are mapped on three REs of 12 REs. Then, there are 144 REs are mapped with PBCH DMRS. Accordingly, the sequence length of PBCH DMRS is 144.

In some implementations, for a first frequency range (FR1) (e.g. sub-6 GHz frequency), three-bit timing information, e.g., indicating an SSB index or an SSB index and half frame indication, is carried by PBCH DMRS. Eight sequences, corresponding to 3 bits, may be defined for PBCH DMRS per cell. A UE may first detect the PBCH DMRS sequence from a base station, and then perform channel estimation for PBCH decoding. The UE may obtain the specific location of the SSB, which is determined by the SSB index, in a half frame by performing correlation detection between the DMRS sequence received in an SSB and the eight local DMRS sequences.

In some implementations, eight sequences are defined for PBCH DMRS per cell in NR. That is, three bits information is carried by PBCH DMRS. So that, SSB index or SSB index and half frame indication can be indicated by initializing DMRS sequence as following equation, wherein Cᵢₙᵢₜ is an initial value and N_{ID}^{cell} is the cell identifier (ID) number.

$${c}_{init} = {2}^{11} ( {\overline{i}}_{SSB} + 1 ) ( ⌊ {N}_{I D}^{cell} / 4 ⌋ + 1 ) + {2}^{6} ( {\overline{i}}_{SSB} + 1 ) + ( {N}_{I D}^{cell} mod 4 )$$

In some implementations, there are 1008 unique physical-layer cell identities (PCIs) given by N_{ID}^{cell}=3N_{ID}⁽¹⁾+N_{ID}⁽²⁾, where N_{ID}⁽¹⁾∈{0, 1, . . . , 335} and N_{ID}⁽²⁾∈{0, 1, 2}. For NR, there are 3 different sequences of PSS signal and 336 different sequences of SSS signal for each of PSS signal to indicate the 1008 PCIs.

In some implementations, a physical downlink control channel (PDCCH) may be transmitted in a CORESET by using one or more control channel element (CCE). Each CCE may consist of 6 resource element groups (REGs). The number of CCEs corresponds to a supported PDCCH aggregation level, for example, 1, 2, 4, 8, or 16.

In some implementations, according to a control resource set (e.g., CORESET #0) configuration table, a minimum number of RBs for CORESET #0 is 24. For an example shown in FIG. 1C, a PDCCH candidate for PDCCH transmission may occupy one or more CCEs according to an aggregation level. For each CCE, the included RBs may be distributed under the mode of interleaved mapping. For dedicated spectrum less than 5 MHz, e.g., 3 MHz, there may be only 15 or 16 RBs available. The RBs for PDCCH transmission exceeding the system bandwidth can not be used. The corresponding information on these RBs may be punctured, which results in a reduction of the aggregation level supported by CORESET #0 configuration. a severe performance degradation. FIG. 1C shows a first bandwidth (including 24 RBs) of CORESET #0 and puncture. The max aggregation level is 4 that may be supported by the PDCCH after being interleveled and punctured 4 RBs.

The present disclosure describes various embodiments for transmitting information with limited channel bandwidth, addressing at least one of issues/problems discussed above, minimizing the degradation of PBCH reception, minimizing the degradation due to shortage of PDCCH coverage, and thus improving the performance of the wireless communication.

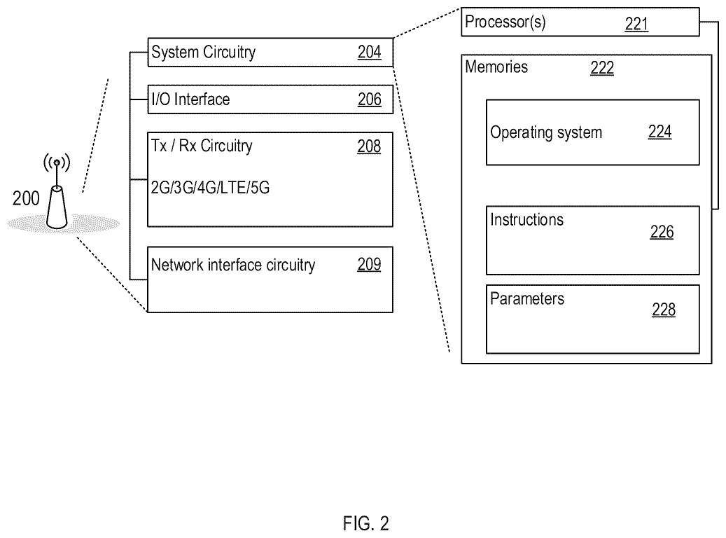

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

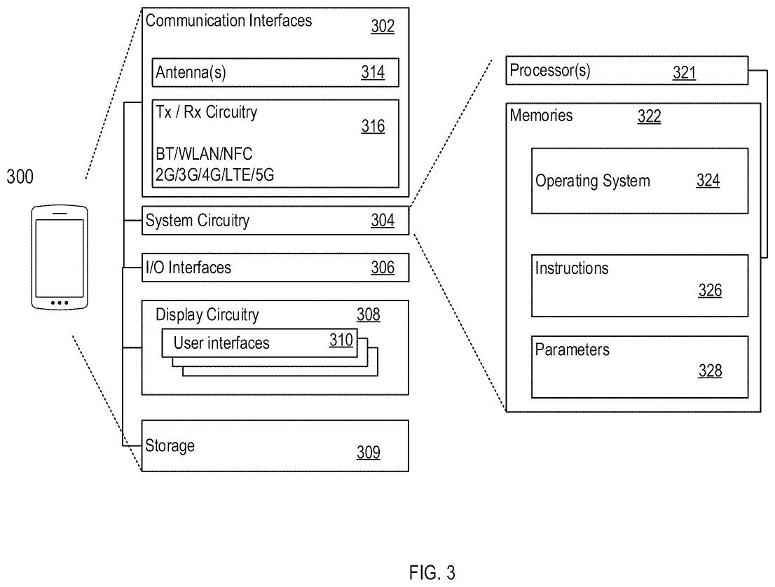

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), and 5G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several below embodiments, which may be implemented, partly or totally, on the network base station and/or the user equipment described above in FIGS. 2-3.

In some implementations, the supported minimum bandwidth may be 5 MHz in normal circumstances (e.g., when the subcarrier spacing (SCS) is 15 KHz). In some special scenarios, such as railway (e.g., future railway mobile communication system (FRMCS)), smart grids, and/or public safety, the available frequency domain resources of some operators may be less than 5 MHz (e.g., 2.8˜3.6 MHz or 3 MHz). For example, when the defined minimum bandwidth is less than 3.6 MHz, the original synchronization signal (SS) or physical broadcast channel (PBCH) block may exceed the minimum bandwidth; and the one or more resource block (RB) of SS/PBCH block that exceeds the minimum bandwidth may be punctured, resulting in performance degradation or failure to work.

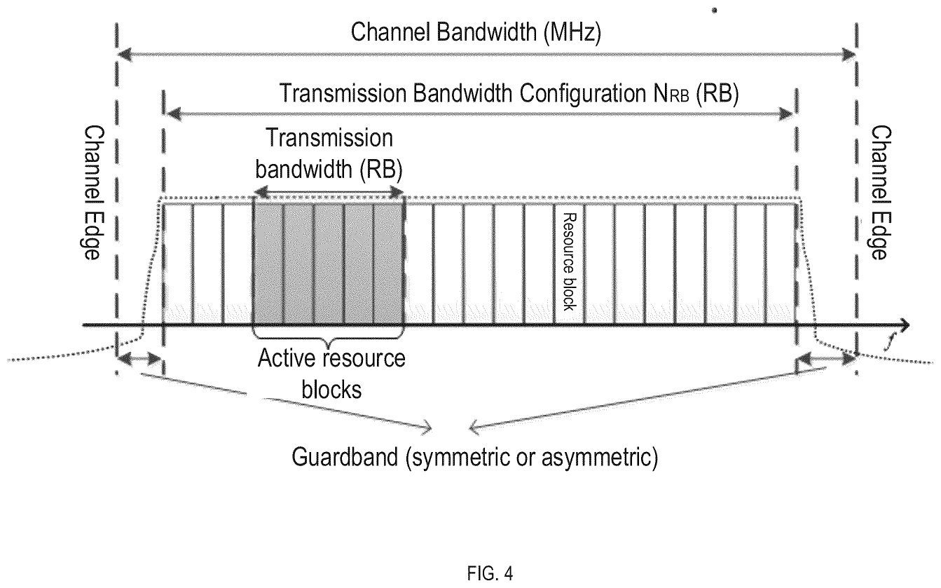

In various embodiments in the present disclosure, a channel bandwidth (BW) refers to several fixed RF bandwidth configurations supported by the UE, such as 5 MHz and 10 MHz; and a transmission bandwidth configuration refers to a number of RBs actually used to transmit content in the channel bandwidth of the UE. That is, the transmission bandwidth configuration is included within the channel bandwidth as shown in FIG. 4, but may not fully occupy the channel bandwidth. Since the number of available RBs in different scenarios such as smart grids and public protection and disaster relief (PPDR) may be different, defining different transmission bandwidths (such as, 12 RBs, 15 RBs, etc.) are required for a same channel bandwidth such as 3 MHz. For the application scenario such as FRMCS in band n100, due to a coexistence requirement of the GSM-R and the FRMCS, different transmission bandwidths may be defined for a same channel bandwidth. While multiple transmission BWs defining under one channel BW, it is necessary to indicate the different transmission bandwidths for UE to receive information.

The present disclosure describes various embodiments for wireless communication with limited channel bandwidth, addressing at least one of issues/problems discussed above, minimizing the degradation of PBCH reception, minimizing the degradation due to shortage of PDCCH coverage, and thus improving the performance of the wireless communication.

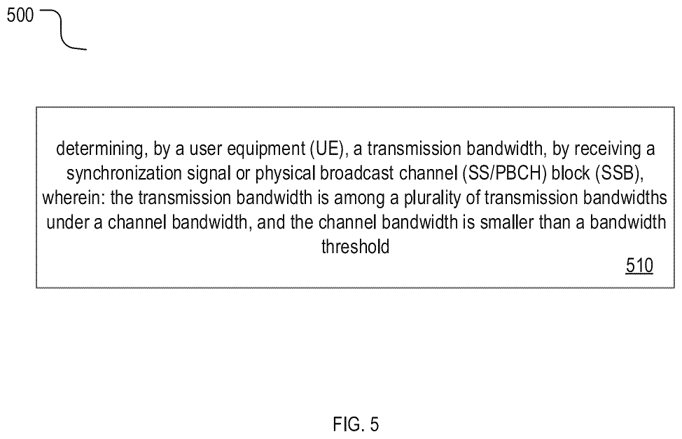

Referring to FIG. 5, the present disclosure describes various embodiments of a method 500 for wireless communication. The method 500 includes step 510, determining, by a user equipment (UE), a transmission bandwidth, by receiving a synchronization signal or physical broadcast channel (SS/PBCH) block (SSB), wherein the transmission bandwidth is among a plurality of transmission bandwidths under a channel bandwidth, and the channel bandwidth is smaller than a bandwidth threshold.

In some implementations, the bandwidth threshold is 5 MHz, and/or the SSB comprises a primary synchronization signal (PSS), a secondary synchronization signal (SSS), and/or a PBCH demodulation reference signal (DMRS).

In some implementations, the UE determines the transmission bandwidth based on receiving SSB in different operating bands, and/or the different operating bands correspond to a specific area or purpose.

In some implementations, the UE derives a global synchronization channel number (GSCN) from a frequency position of the SSB, and/or the UE determines the transmission bandwidth based on the GSCN.

In some implementations, the UE determines the transmission bandwidth based on the GSCN by at least one of the following: deriving a parameter from the GSCN according to a formula and using the parameter to determine the transmission bandwidth, or obtaining a remainder by the GSCN mod m, and using the remainder to determine the transmission bandwidth, wherein mod is a modulo operation, and m is an integer being equal to or larger than a number of transmission bandwidths under a same channel bandwidth.

In some implementations, the UE determines the transmission bandwidth based on a frequency position of the SSB by: obtaining a remainder by (f/rf) mod m, wherein f is the frequency position of the SSB, rf is a raster frequency, and m is an integer being equal to or larger than a number of transmission bandwidths under a same channel bandwidth; and/or using the remainder to determine the transmission bandwidth.

In some implementations, the raster frequency corresponds to a fixed synchronization raster frequency of N*100 KHz, wherein N is a positive integer.

In some implementations, the UE determines the transmission bandwidth based on a sequence of the PSS in the SSB by obtaining, based on the sequence of the PSS, a cyclic shift for a base sequence corresponding to the sequence of the PSS, deriving, according to the cyclic shift for the base sequence, an index for the transmission bandwidth, and/or determining, based on the index, the transmission bandwidth under a same channel bandwidth.

In some implementations, the sequence of the PSS is one of three different PSS sequences, each of which indicates a different transmission bandwidth.

In some implementations, the UE determines the transmission bandwidth based on a sequence of the SSS in the SSB by obtaining, based on the sequence of the SSS, a cyclic shift for a base sequence corresponding to the sequence of the SSS, deriving, according to the cyclic shift for the base sequence, an index for the transmission bandwidth, and/or determining, based on the index, the transmission bandwidth under the channel bandwidth.

In some implementations, the sequence of the SSS is one of 336 different SSS sequences, the 336 different SSS sequences are classified into Q groups, wherein Q is an integer being equal to or larger than a number of transmission bandwidths under a same channel bandwidth, and/or the derived index corresponds to a group among the Q groups, and the sequence of the SSS belongs to the group.

In some implementations, the UE determines the transmission bandwidth based on a sequence of the SSS in the SSB by obtaining, based on the sequence of the SSS, an interleaving sequence corresponding to the sequence of SSS, deriving, according to the interleaving sequence, an index for the transmission bandwidth, and/or determining, based on the index, the transmission bandwidth under the channel bandwidth.

In some implementations, the sequence of the SSS is one of two different interleaving SSS sequences, and/or the two different interleaved sequences are obtained by interleaving two base sequences in different interleaving order.

In some implementations, the UE determines the transmission bandwidth based on a sequence of the PBCH DMRS in the SSB by obtaining, based on the sequence of the PBCH DMRS, a parameter for initializing a scrambling sequence generator corresponding to the sequence of the PBCH DMRS, deriving, based on the parameter, an index for the transmission bandwidth, and/or determining, based on the index, the transmission bandwidth under the channel bandwidth.

In some implementations, the index has one bit, representing two transmission bandwidths under a same channel bandwidth; the parameter has three bits comprising one bit of a half-frame timing, one bit of the index, and a least significant bit (LSB) of an SSB index; and/or a most significant bit (MSB) of the SSB index is obtained from a set of bits in a PBCH payload, a ssb-SubcarrierOffset or a subCarrierSpacingCommon in a master information block (MIB).

In some implementations, the index has two bits, representing four transmission bandwidths under a same channel bandwidth; the parameter has three bits comprising one bit of a half-frame timing and the two bits of the index; and/or two bits of an SSB index are obtained from a set of bits in a PBCH payload, ssb-SubcarrierOffset or a subCarrierSpacingCommon in the MIB.

In some implementations, the index has one bit, representing two transmission bandwidths under a same channel bandwidth; the parameter has three bits comprising one bit of the index and two bits of an SSB index; and/or one bit of a half-frame timing is indicated by a fifth bit in a PBCH payload, ssb-SubcarrierOffset or a subCarrierSpacingCommon in the MIB.

In some implementations, the index has two bits, representing four transmission bandwidths under a same channel bandwidth; the parameter has three bits comprising the two bit of the index and a LSB of an SSB index; one bit of a half-frame timing is indicated by a fifth bit in a PBCH payload; and/or a most significant bit (MSB) of the SSB index is obtained from a set of bits in a PBCH payload, ssb-SubcarrierOffset or a subCarrierSpacingCommon in the MIB.

In some implementations, the set of bits in the PBCH payload comprises three bits comprising a sixth bit, a seventh bit, and an eighth bit in the PBCH payload.

### Embodiment Set I

The present disclosure describes various embodiments of a method, a system, or computer-readable medium for indicating the different transmission bandwidths corresponding to a same channel bandwidth.

In some embodiments, different operating bands are defined for different transmission bandwidths corresponding to a same channel bandwidth. For example, for a channel bandwidth of 3 MHz, two potential transmission bandwidths (e.g., 15 RBs and 12 RBs) may be supported. Then, two operating bands are defined for them, operating band X with upper and lower frequency boundaries is defined for 15 RBs transmission bandwidth, and operating band Y is defined for 12 RBs transmission bandwidth. There may be frequency overlap between these bands, which generally may not be a problem as different transmission bandwidths are not used in the same area (e.g., same country). Therefore, for a specific area or purpose, the UE may support a specific band to uniquely determine the supported transmission bandwidth.

In some embodiments, a global synchronization channel number (GSCN) which corresponds to a frequency position of the SS block (defined as SS_{REF}) is given by a formula for dedicated spectrum less than 5 MHz. In some implementations, one or more parameters in the formula may be related to the transmission bandwidth.

For an example, the formula may be 3N+(M−3)/2 with N and M are integers. The parameter M can be a value in {1, 3, 5}. The different values of M can be used respectively to indicate different transmission bandwidths. Thus, when detecting the SSB, the UE can obtain current corresponding transmission bandwidth according to an M value calculated according to a frequency location of the detected SSB, so as to receive a subsequent signal.

For another example, in the formula of 3N+(M−3)/2, The parameter N may be a value from 1 to 2499. The different values of N can be used respectively to indicate different transmission bandwidths. When detecting the SSB, the UE can learn of a current corresponding transmission bandwidth according to the value of N obtained by means of calculation according to a frequency location at which the UE detects the SSB, so as to receive a subsequent signal.

For another example, in the formula of 3N+(M−3)/2, M can be a value in {1, 3, 5} and N can be a value from 1 to 2499. Different value combinations of {N, M} can be used to indicate different transmission bandwidths. When detecting the SSB, the UE can learn of a current corresponding transmission bandwidth according to the value combinations of {N, M} obtained by means of calculation according to a frequency location at which the UE detects the SSB, so as to receive a subsequent signal.

In some embodiments, a value of GSCN mod m is used to indicate different transmission bandwidth, wherein mod is a modulo operation returning the remainder of the division, and m is equal to or larger than the quantity of different transmission bandwidths under a same channel bandwidth. When detecting the SSB, the UE may determine a current corresponding transmission bandwidth according to the value of GSCN mod m, and the GSCN is obtained by means of calculation according to a frequency location at which the UE detects the SSB, so as to receive a subsequent signal.

In some embodiments, a synchronization raster is fixedly defined as 100 KHz for a dedicated spectrum less than 5 MHz, a value of (SS_{REF}/synchronization raster) mod n may be used to indicate different transmission bandwidths, and SS_{REF} is the frequency position of SS block, n is equal to or larger than the quantity of transmission bandwidths under a same channel bandwidth. In other words, the value is a remainder when a quotation of dividing the frequency position of the SSB by a raster frequency is divided by m. In some implementations, the synchronization raster frequency may be a positive integer times 100 KHz, for example, 200 KHz, 300 KHz, 500 KHz, 800 KHz, or etc.

For example, the channel bandwidth is 3 MHz, and there are two types of transmission bandwidths: 15 RBs and 16 RBs, so that the quantity of transmission bandwidths under a same channel bandwidth is 2. For one example, n=2 is selected; when (SS_{REF}/100 kHz) mod 2=0, the transmission bandwidth is indicated as 15 RBs, and when (SS_{REF}/100 KHz) mod 2=1, the transmission bandwidth is indicated as 16 RBs.

### Embodiment Set II

The present disclosure describes various embodiments of a method, a system, or computer-readable medium for indicating the different transmission bandwidth by using PSS or SSS sequence. In some implementations, the PSS and/or SSS sequence can be used to indicate different transmission bandwidths since an application scenario of the dedicated spectrum system is relatively simple and there is no need to indicate so many as 1008 cell ID.

In some embodiment, different sequences of PSS signal are used to indicate different transmission bandwidths. For example, there are three different sequences of PSS signal: {x₀}, {x₁}, and {x₂}, which respectively correspond to different cyclic shifts of a base maximum length sequence (M-sequence), whose length is 127 as shown in the following equation.

$${x}_{0} ( n ) = x ( n ) = x ( n + 0 * 43 mod 127 ) \\ {x}_{1} ( n ) = x ( n + 43 mod 127 ) = x ( n + 1 * 43 mod 127 ) \\ {x}_{2} ( n ) = x ( n + 86 mod 127 ) = x ( n + 2 * 43 mod 127 )$$

In some implementations, three kinds of different transmission bandwidths are defined with transmission band index (i_{band}), and i_{band} may be {0, 1, 2}. Each value of the index (i_{band}) corresponds to a different cyclic shifts of a base M-sequence; and in other words, each value of i_{band} corresponds to a different cyclic shifts of a specific sequence of the PSS signal, as below.

$${d}_{P S S} = x ( n + ( 43 {i}_{b a n d} ) mod 127 )$$

Therefore, the three different cyclic shifts of sequence of PSS signal can be used to indicate three different transmission bandwidths. When an SSS signal is detected, the current transmission bandwidth can be determined by identifying which specific sequence it is. The number of cell IDs that can be indicated by using SSS signal is 336.

In some embodiments, different sequences of SSS signal are used to indicate different transmission bandwidths. In some implementations, there may be 336 different sequences of SSS signal for each of the PSS signal, and each sequence respectively corresponds to a different cyclic shifts. The 336 different sequences can be classified into Q groups. Q is equal to or larger than the quantity of different transmission bandwidths. Q kinds of different transmission bandwidth are defined with transmission band index (i_{band}), and i_{band} may be {0, 1, 2, . . . , Q−1} respectively. Each value of i_{band} corresponds to a set of different cyclic shifts; and in other words, each value of i_{band} corresponds to a specific set of sequences of SSS signal. When an SSS signal is detected, the current transmission bandwidth can be determined by identifying which specific set the sequence belongs. The number of cell IDs that can be indicated by using PSS signal and SSS signal is 3*(336/Q).

In some embodiments, different interleaving sequences of m₁ and m₂ of SSS signal may be used to indicate two kinds of different transmission bandwidths. Similar to the sequence of SSS signal in some implementations, two M-sequences (m₁ and m₂) with the length of 31 are interleaved to generate two types of SSSs: SSS₁ and SSS₂. For example, in SSS₁, the sequence of m₁ is in front of the sequence of m₂; and in SSS₂, the sequence of m₂ is in front of the sequence of m₁. After receiving SSS signal, the current transmission bandwidth can be obtained by detecting which sequence of SSS₁ and SSS₂.

### Embodiment Set III

The present disclosure describes various embodiments of a method, a system, or computer-readable medium for indicating different transmission bandwidth by using a PBCH DMRS sequence. The base station may initialize a scrambling sequence generator of PBCH DMRS sequence by defining parameter ī_{SSB}=i_{SSB}+4n_{hf}. In some implementations, in scenarios where the frequency is lower than 3 GHz, the maximum number of SS/PBCH blocks contained in the SS block burst set is 4, so that i_{SSB} is 0, 1, 2, and 3, respectively. In other words, there are 2 bits information of SSB index carried by the DMRS sequence. In some implementations, in a first frequency range (FR1), some bits of PBCH payload is reserved or may be reused to indicate the SSB index, so that the 2 bits of SSB index carried by DMRS sequence can be used to indicate the different transmission bandwidth.

In some embodiments, two kinds of different transmission bandwidth are defined with transmission band index (i_{band}), and i_{band} may be 0, or 1, respectively. The different PBCH DMRS sequences are used to indicate two kinds of transmission bandwidth and two kinds of SSB index. So, another 1 bit is required for indicating 1 MSB of SSB index, which may be any one of the following three bits (i.e., ā_{Ā+5}, ā_{Ā+6}, ā_{Ā+7}) in the PBCH payload. In other words, the PBCH DMRS sequence is initialized by (ī_{SSB}=i_{SSB}+2i_{band}+4n_{hf}), which including 1 bit of transmission band index, 1 LSB of SSB index and 1 bit of half-frame timing. In ī_{SSB}, 1 bit of half-frame timing is at its MSB, followed by 1 bit of transmission band index, and then followed by 1 LSB of SSB index at its LSB. The sequence of PBCH DMRS is generated by defining parameter ī_{SSB}=i_{SSB}+2i_{band}+4n_{hf} in the following equation. In some implementations, 1 MSB of SSB index may be any bit of a ssb-SubcarrierOffset or a subCarrierSpacingCommon in the MIB.

$${c}_{init} = {2}^{11} ( {\overline{i}}_{SSB} + 1 ) ( ⌊ {N}_{I D}^{cell} / 4 ⌋ + 1 ) + {2}^{6} ( {\overline{i}}_{SSB} + 1 ) + ( {N}_{I D}^{cell} mod 4 )$$

In some embodiments, four kinds of different transmission bandwidths are defined with transmission band index (i_{band}), and i_{band} may be 0, 1, 2, or 3, respectively. The different PBCH DMRS sequences are used to indicate 4 kinds of transmission bandwidths. The 2 bits to indicate SSB index can be either 2 bits of the following two bits (i.e., ā_{Ā+5}, ā_{Ā+6}, ā_{Ā+7}) in the PBCH payload. In other words, the PBCH DMRS sequence is initialized by 2 bits of transmission band index and 1 bit of half-frame timing. The sequence of PBCH DMRS is generated by defining parameter ī_{SSB}=i_{band}+4n_{hf} in the following equation. In some implementations, the two bits of SSB index may be either 2 bits of a ssb-SubcarrierOffset or a subCarrierSpacingCommon in the MIB.

$${c}_{init} = {2}^{11} ( {\overline{i}}_{SSB} + 1 ) ( ⌊ {N}_{I D}^{cell} / 4 ⌋ + 1 ) + {2}^{6} ( {\overline{i}}_{SSB} + 1 ) + ( {N}_{I D}^{cell} mod 4 )$$

The PBCH DMRS sequence is generated by defining parameter ī_{SSB}=i_{SSB}+4n_{hf}, where n_{hf} is the half-frame timing, which is re-indicated by ā_{Ā+4} in PBCH payload. Therefore, the n_{hf} information carried by DMRS sequence may be reused to indicate different transmission bandwidth for the dedicated spectrum less than 5 MHz which frequency range is around 900 MHz.

In some embodiments, two kinds of different transmission bandwidths are defined with transmission band index (i_{band}), and i_{band} may be 0 or 1, respectively. The different PBCH DMRS sequences are used to indicate two kinds of transmission bandwidths and four kinds of SSB index. In other words, the PBCH DMRS sequence is initialized by 1 bit of transmission band index and 2 bit of SSB index. The sequence of PBCH DMRS is generated by defining parameter ī_{SSB}=i_{SSB}+4i_{band} in the following equation.

$${c}_{init} = {2}^{11} ( {\overline{i}}_{SSB} + 1 ) ( ⌊ {N}_{I D}^{cell} / 4 ⌋ + 1 ) + {2}^{6} ( {\overline{i}}_{SSB} + 1 ) + ( {N}_{I D}^{cell} mod 4 )$$

In some embodiments, four kinds of different transmission bandwidths are defined with transmission band index (i_{band}), and i_{band} may be 0, 1, 2, or 3, respectively. The different PBCH DMRS sequences are used to indicate 4 kinds of transmission bandwidths and 1 LSB of SSB index. So, another 1 bit is required for indicating 1 MSB of SSB index, which may be either one of the following three bits (i.e., ā_{Ā+5}, ā_{Ā+6}, ā_{Ā+7}) in the PBCH payload. In other words, the PBCH DMRS sequence is initialized by 2 bits of transmission band index and 1 LSB of SSB index. The sequence of PBCH DMRS is generated by defining parameter ī_{SSB}=i_{band}+4i_{SSB} in the following equation. In some implementations, 1 MSB of SSB index may be any bit of a ssb-SubcarrierOffset or a subCarrierSpacingCommon in the MIB.

$${c}_{init} = {2}^{11} ( {\overline{i}}_{SSB} + 1 ) ( ⌊ {N}_{I D}^{cell} / 4 ⌋ + 1 ) + {2}^{6} ( {\overline{i}}_{SSB} + 1 ) + ( {N}_{I D}^{cell} mod 4 )$$

### Embodiment Set IV

The present disclosure describes various embodiments of a method, a system, or computer-readable medium for reducing system performance loss caused by limited frequency domain resources.

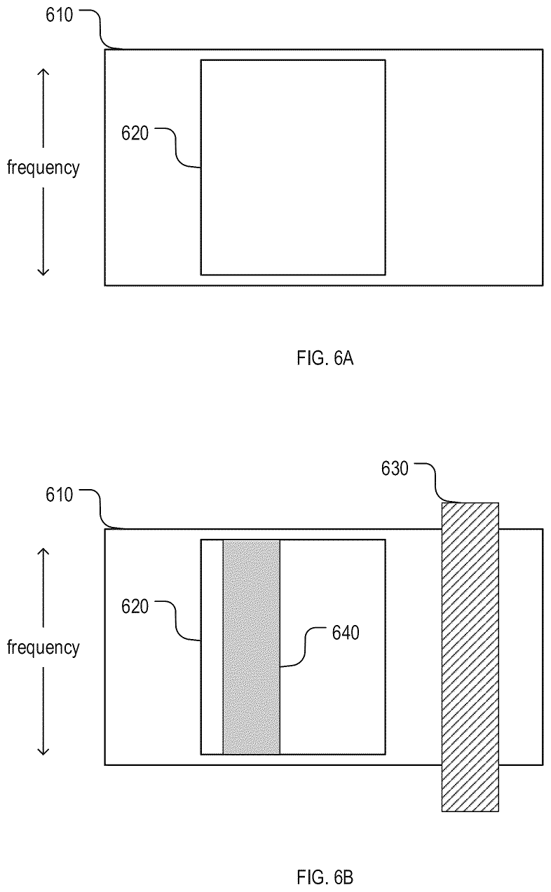

In some embodiments, as shown in FIG. 6A, an initial downlink bandwidth part (DL BWP) (620) is defined within an available system bandwidth (610), and the initial DL BWP is smaller than or equal to the available system bandwidth in frequency domain.

In some embodiments, referring to FIG. 6B, a first bandwidth (630) of a control resource set number zero (e.g., CORESET #0) is configured to receive a system information block (SIB1) PDCCH, and a second bandwidth (640) of CORESET #0 is configured to receive signals other than SIB1 PDCCH, such as, at least one of, paging, SIBs other than SIB1 (OSI), Msg2, Msg4, or other unicast PDCCH. In some implementations, the first bandwidth of CORESET #0, e.g., including 24 RBs, may be configured by PBCH. The number of resources occupied by the second bandwidth of CORESET #0 in the frequency domain is the same as the initial DL BWP configured by SIB1 as shown in FIG. 6B.

In some implementations, for CORESET #0 configuration with the first bandwidth, some data may be punctured due to the limited channel bandwidth. UEs are required to determine the dedicated spectrum range to detect PDCCH after puncturing.

In some implementations, the dedicated spectrum range is determine from the determined system bandwidth. In some implementations, k_{ssb}=0 which means the sync raster is overlap with channel raster in RAN4 definition, the frequency location and the RBs available of the system bandwidth would be determined as the same as SSB bandwidth. In some implementations, k_{ssb}≠0, the frequency location of system BW would be SS_{REF}−k_{ssb}, and the RBs available of system bandwidth would be one RB more than those are used for SSB transmission.

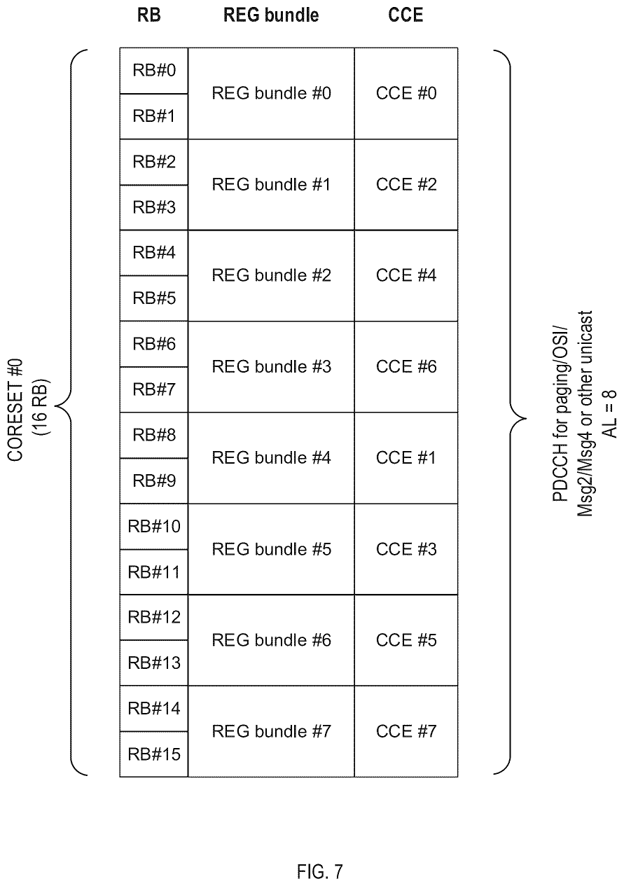

In some implementations, for PDCCH detected within CORESET #0 with the second bandwidth, PDCCH candidates are mapped within the second bandwidth of CORESET #0. FIG. 7 shows a second bandwidth (16 RB) of CORESET #0 in the available system bandwidth, showing that a higher aggregation level (e.g., AL=8) may be supported on a similarly limited frequency domain resource, in other words, a larger coverage may be supported than the puncture scheme as is shown in FIG. 1C.

In some embodiments, methods may be described for solving issues related to power boosting. Power boosting may be used for PBCH to reduce the performance loss due to the number of RBs reduction. This may lead to an inconsistency on measurement, e.g., synchronization signal reference signal received power (SS-RSRP), between the value obtained from measuring PBCH DMRS and that obtained from measuring SSS during neighbor cell measurement. The problem can be solved by defining an offset of PBCH DMRS energy per resource element (EPRE) to SSS EPRE and inform the offset as well as the number of RBs to neighbor cell or UEs under neighbor cell.

In some embodiments, the number of OFDM symbols of CORESET #0 can be extended (e.g., to 4) to reduce the PDCCH reception performance loss due to the number of RBs reduction. This may lead to a conflict between PDSCH DMRS and the extended PDCCH.

Some embodiments for solving the conflict between PDSCH DMRS and the extended PDCCH may include extending the definition of the time-domain symbol position of the PDSCH DMRS. For example, it is allowed to map the PDSCH DMRS based on slot scheduling from the fifth and sixth symbols of the slot. In another words, for PDSCH mapping type A, DMRS-TypeA-Position=pos4 or DMRS-TypeA-Position=pos5 is allowed.

Some embodiments for solving the conflict between PDSCH DMRS and the extended PDCCH, wherein a PDSCH DMRS on the fifth or the sixth OFDM symbol in a slot conflicts with DCI information of a extended PDCCH. One method includes that the PDSCH DMRS performs mapping on a resource other than the conflict in a rate matching manner, to ensure integrity of the extended PDCCH information.

Some embodiments for solving the conflict between PDSCH DMRS and the extended PDCCH, wherein a PDSCH DMRS on the fifth or the sixth OFDM symbol in a slot conflicts with PDCCH DMRS of a extended PDCCH. One method including not sending PDSCH DMRS on the conflicting resources. So, PDCCH and PDCCH share PDCCH DMRS, which means PDSCH use the PDCCH DMRS to perform a channel estimation.

The present disclosure describes methods, apparatus, and computer-readable medium for wireless communication. The present disclosure addressed the issues with wireless communication with limited channel bandwidth. The methods, devices, and computer-readable medium described in the present disclosure may facilitate the performance of wireless transmission between a user equipment and a base station, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE), a transmission bandwidth, by receiving a synchronization signal or physical broadcast channel (SS/PBCH) block (SSB); and
wherein:
the transmission bandwidth is among a plurality of transmission bandwidths and in a channel bandwidth, and
the channel bandwidth is smaller than a bandwidth threshold.

2. The method according to claim 1, wherein:
the bandwidth threshold is 5 MHz, and
the SSB comprises a primary synchronization signal (PSS), a secondary synchronization signal (SSS), and a PBCH demodulation reference signal (DMRS).

3. (canceled)

4. The method according to claim 1, further comprising:
deriving, by the UE, a global synchronization channel number (GSCN) from a frequency position of the SSB, and
determining, by the UE, the transmission bandwidth based on the GSCN.

5. The method according to claim 4, wherein the determining the transmission bandwidth based on the GSCN comprises at least one of the following:
deriving a parameter from the GSCN according to a formula and using the parameter to determine the transmission bandwidth, or
obtaining a remainder by the GSCN mod m, and using the remainder to determine the transmission bandwidth, wherein mod is a modulo operation, and m is an integer being equal to or larger than a number of transmission bandwidths under a same channel bandwidth.

6. The method according to claim 1, further comprising:
determining, by the UE, the transmission bandwidth based on a frequency position of the SSB by:
obtaining a remainder by (f/rf) mod m, wherein f is the frequency position of the SSB, rf is a raster frequency, and m is an integer being equal to or larger than a number of transmission bandwidths under a same channel bandwidth; and
using the remainder to determine the transmission bandwidth.

7. The method according to claim 6, wherein:
the raster frequency corresponds to a fixed synchronization raster frequency of N*100 kHz, wherein N is a positive integer.

8. The method according to claim 1, further comprising:
determining, by the UE, the transmission bandwidth based on a sequence of the PSS in the SSB by:
obtaining, based on the sequence of the PSS, a cyclic shift for a base sequence corresponding to the sequence of the PSS,
deriving, according to the cyclic shift for the base sequence, an index for the transmission bandwidth, and
determining, based on the index, the transmission bandwidth under a same channel bandwidth.

9. (canceled)

10. The method according to claim 1, further comprising:
determining, by the UE, the transmission bandwidth based on a sequence of the SSS in the SSB by:
obtaining, based on the sequence of the SSS, a cyclic shift for a base sequence corresponding to the sequence of the SSS,
deriving, according to the cyclic shift for the base sequence, an index for the transmission bandwidth, and
determining, based on the index, the transmission bandwidth under the channel bandwidth.

11-21. (canceled)

22. The method according to claim 1, wherein:
the plurality of transmission bandwidths comprises 15 resource blocks (RBs) and 12 RBs; and
the channel bandwidth is 3 MHz.

23. The method according to claim 1, further comprising:
determining, by the UE, the transmission bandwidth in band n100.

24. An apparatus comprising:
a memory storing instructions; and
at least one processor in communication with the memory, wherein, when the at least one processor executes the instructions, the at least one processor is configured to cause the apparatus to perform:
determining a transmission bandwidth, by receiving a synchronization signal or physical broadcast channel (SS/PBCH) block (SSB); and
wherein:
the transmission bandwidth is among a plurality of transmission bandwidths and in a channel bandwidth, and
the channel bandwidth is smaller than a bandwidth threshold.

25. The apparatus according to claim 24, wherein:
the bandwidth threshold is 5 MHz, and
the SSB comprises a primary synchronization signal (PSS), a secondary synchronization signal (SSS), and a PBCH demodulation reference signal (DMRS).

26. The apparatus according to claim 24, wherein, when the at least one processor executes the instructions, the at least one processor is configured to cause the apparatus to perform:
deriving a global synchronization channel number (GSCN) from a frequency position of the SSB, and
determining the transmission bandwidth based on the GSCN.

27. The apparatus according to claim 24, wherein:
the plurality of transmission bandwidths comprises 15 resource blocks (RBs) and 12 RBs; and
the channel bandwidth is 3 MHz.

28. The apparatus according to claim 24, wherein, when the at least one processor executes the instructions, the at least one processor is configured to cause the apparatus to perform:
determining the transmission bandwidth in band n100.

29. A non-transitory computer-readable medium storing instructions, wherein, the instructions, when executed by a computer, are configured to cause the computer to perform:
determining a transmission bandwidth, by receiving a synchronization signal or physical broadcast channel (SS/PBCH) block (SSB); and
wherein:
the transmission bandwidth is among a plurality of transmission bandwidths and in a channel bandwidth, and
the channel bandwidth is smaller than a bandwidth threshold.

30. The non-transitory computer-readable medium according to claim 29, wherein:
the bandwidth threshold is 5 MHz, and
the SSB comprises a primary synchronization signal (PSS), a secondary synchronization signal (SSS), and a PBCH demodulation reference signal (DMRS).

31. The non-transitory computer-readable medium according to claim 29, wherein, wherein, the instructions, when executed by the computer, are configured to cause the computer to perform:
deriving a global synchronization channel number (GSCN) from a frequency position of the SSB, and
determining the transmission bandwidth based on the GSCN.

32. The non-transitory computer-readable medium according to claim 29, wherein:
the plurality of transmission bandwidths comprises 15 resource blocks (RBs) and 12 RBs; and
the channel bandwidth is 3 MHz.

33. The non-transitory computer-readable medium according to claim 29, wherein, wherein, the instructions, when executed by the computer, are configured to cause the computer to perform:
determining the transmission bandwidth in band n100.
